(19) United States
(12) Patent Application Publication
(10) Pub. No.: US 2026/0163093 A1
(43) Pub. Date: Jun. 11, 2026

(54) METHOD OF SEPARATING ALUMINUM CURRENT COLLECTOR FROM CATHODE OF LITHIUM BATTERY

(71) Applicant: Korea Institute Of Geoscience And Mineral Resources, Daejeon (KR)

(72) Inventors: Jong-won CHOI, Jeonju-si (KR); Soo-Kyung KIM, Sejong-si (KR); Hyun-Ju LEE, Daejeon (KR); Moo-Ki BAE, Sejong-si (KR); Hyun-Joon LEE, Daejeon (KR)

(73) Assignee: Korea Institute Of Geoscience And Mineral Resources, Daejeon (KR)

(21) Appl. No.: 19/179,350

(22) Filed: Apr. 15, 2025

(30) Foreign Application Priority Data
Apr. 18, 2024 (KR) 10-2024-0051910

(51) Int. Cl. H01M 10/54; B09B 3/80; B09B 101/16

(52) U.S. Cl. CPC H01M 10/54; B09B 3/80; B09B 2101/16

(57) ABSTRACT

The purpose of the present disclosure is to provide a method of separating an aluminum current collector from a cathode material of a lithium battery, which reduces process steps and chemical consumption in technologies for recycling or reusing spent lithium batteries. In order to achieve the purpose, an aspect of the present disclosure provides a method of separating an aluminum current collector from a cathode material of a lithium battery, the method comprising: (a) separating, from a lithium battery, a cathode current collector including a cathode material, an anode current collector including an anode material, and a separator; (b) impregnating the cathode current collector including the cathode material in a solvent; and (c) activating a cathode material delamination reaction by stirring the solvent.

### CROSS-REFERENCE TO RELATED APPLICATION

This application claims priority to Korean Patent Application No. 10-2024-0051910 filed on Apr. 18, 2024, and all the benefits accruing therefrom under 35 U.S.C. § 119, the contents of which is incorporated by reference in its entirety.

### BACKGROUND OF THE DISCLOSURE

### 1. Field of the Disclosure

The present disclosure relates to a method of separating an aluminum current collector from a cathode material of a lithium battery. In particular, the present disclosure relates to a method of separating an aluminum current collector from a cathode material of a lithium battery, in order to recycle spent lithium batteries or scraps generated during the lithium battery manufacturing process.

### 2. Description of the Related Art

Lithium batteries are currently the most technologically advanced type of rechargeable chemical battery in the world. They are widely used due to their high operating voltage, relatively high energy density, long charge/discharge cycle life, and low self-discharge rate.

In particular, with the increasing adoption of electric vehicles (EVs, HEVs, and PHEVs), the demand for lithium batteries has rapidly increased. As a result, issues such as supply-demand imbalance, rising costs, and environmental concerns have become more prominent. Accordingly, technologies for recycling or reusing defective lithium batteries generated during the manufacturing process or spent lithium batteries after use are increasingly recognized as being as important as lithium battery production itself.

A lithium battery is composed of a cathode material, an anode material, an electrolyte, a separator, and a current collector.

In the lithium battery, the electrode materials, such as the cathode and anode materials, include active materials such as lithium nickel cobalt manganese oxide (NCM), lithium iron phosphate oxide (LiFePO₄), graphite, and silicon; conducting agents such as CNT and carbon black; and binders such as PVDF, PTFE, and CMC/SBR.

In the conventional art, in order to recycle and reuse the cathode active material in the lithium battery, there have been reported processes for separating the cathode plate and the anode plate from the lithium battery, followed by separating the cathode current collector from the cathode material.

In particular, there have been reports of methods involving immersing the electrodes separated from the lithium battery in solutions such as acidic solutions, alkaline solutions, hydroxide solutions of alkali metals, alcohol solutions of alkali metals, or organic solvents to separate the electrode material from the current collector.

Also reported is a method in which the separated electrodes are immersed in N-methyl-2-pyrrolidone solvent, then heated to volatilize the N-methyl-2-pyrrolidone solvent, thereby separating the electrode material from the current collector.

Another reported method involves immersing the electrodes in an alkaline solution or a mixed aqueous and non-aqueous solution, followed by ultrasonic treatment and heating to achieve separation.

However, such methods require pH control, consume chemical reagents leading to environmental pollution, involve complex process steps, take a long time for separation, and can result in the leaching of metals present in the active materials.

Therefore, in order to overcome these issues, the applicant of the present disclosure has made extensive efforts and has devised a method of separating an aluminum current collector from a cathode material of a lithium battery, which reduces process steps and chemical consumption in technologies for recycling or reusing spent lithium batteries.

### SUMMARY OF THE DISCLOSURE

The purpose of the present disclosure, which aims to solve the aforementioned conventional problems, is to provide a method of separating an aluminum current collector from a cathode material of a lithium battery, which reduces process steps and chemical consumption in technologies for recycling or reusing spent lithium batteries.

The problems to be solved by the present disclosure are not limited to those mentioned above, and other issues not explicitly stated will be clearly understood by those skilled in the art from the following description.

In order to achieve the purpose, an aspect of the present disclosure provides a method of separating an aluminum current collector from a cathode material of a lithium battery, the method comprising:
(a) separating, from a lithium battery, a cathode current collector including a cathode material, an anode current collector including an anode material, and a separator;
(b) impregnating the cathode current collector including the cathode material in a solvent; and
(c) activating a cathode material delamination reaction by stirring the solvent.

In some exemplary embodiments, the cathode material may include a binder containing polyvinylidene fluoride (PVDF).

In some exemplary embodiments, in step (b), the solvent may be an aqueous or non-aqueous solvent.

In some exemplary embodiments, the aqueous solvent may be any one selected from the group consisting of water, distilled water, and deionized water.

In some exemplary embodiments, in step (b), the cathode current collector including the cathode material may be impregnated in an amount of 1 to 3 wt % based on 100 wt % of the solvent.

In some exemplary embodiments, step (c) may be performed at a temperature of 10 to 15° C.

In some exemplary embodiments, step (c) may be performed at 300 to 400 rpm.

In some exemplary embodiments, the cathode material delamination reaction may be performed for 15 to 25 minutes.

In some exemplary embodiments, the method may further comprise, after step (c), a step of recovering the aluminum current collector.

In some exemplary embodiments, after step (c), the pH of the solvent may be in a range of 7 to 9.

In some exemplary embodiments, after step (c), a lithium content of the solvent may be 20 ppm or less.

According to an exemplary embodiment of the present disclosure, there is provided a method of separating an aluminum current collector from a cathode material of a lithium battery, which reduces process steps and chemical consumption in technologies for recycling or reusing spent lithium batteries.

In addition, according to an exemplary embodiment of the present disclosure, there is provided an environmentally friendly method of separating an aluminum current collector from a cathode material of a lithium battery, which enables the separation and reuse of the cathode material and the current collector without using an acid or an alkali.

In addition, according to an exemplary embodiment of the present disclosure, there is provided a method of separating an aluminum current collector from a cathode material of a lithium battery, which mitigates environmental pollution and reduces process costs by eliminating the need for a neutralization process or wastewater treatment.

In addition, according to an exemplary embodiment of the present disclosure, there is provided a method of separating an aluminum current collector from a cathode material of a lithium battery, which is suitable for mass production and enables easy process control by employing a simple and facile process.

In addition, according to an exemplary embodiment of the present disclosure, there is provided a method of separating an aluminum current collector, which enables the recovery of both the cathode material and the aluminum current collector without deterioration in electrochemical performance.

The effects of the present disclosure are not limited to the aforementioned effects and should be understood to include all effects that can be inferred from the configurations of the present disclosure described in the detailed description or the claims.

### BRIEF DESCRIPTION OF THE DRAWINGS

FIG. 1 is a process diagram illustrating a method of separating an aluminum current collector from a cathode material of a lithium battery according to an exemplary embodiment of the present disclosure.

FIG. 2 is a photograph showing a cathode current collector of a lithium battery impregnated in a solvent according to an exemplary embodiment of the method of separating an aluminum current collector from a cathode material of a lithium battery of the present disclosure.

FIG. 3 is a photograph showing a delamination reaction of the cathode material performed according to an exemplary embodiment of the method of separating an aluminum current collector from a cathode material of a lithium battery of the present disclosure.

FIG. 4 is a photograph showing the recovered aluminum current collector after delamination, according to an exemplary embodiment of the method of separating an aluminum current collector from a cathode material of a lithium battery of the present disclosure.

### DETAILED DESCRIPTION OF THE DISCLOSURE

The purpose of the present disclosure, which aims to solve the aforementioned conventional problems, is to provide

Before describing the present disclosure in detail, the terms or words used in this specification should not be construed as being unconditionally limited to their ordinary or dictionary meanings, and in order for the inventor of the present disclosure to describe his/her disclosure in the best way, concepts of various terms may be appropriately defined and used, and furthermore, the terms or words should be construed as means and concepts which are consistent with a technical idea of the present disclosure.

That is, the terms used in this specification are only used to describe preferred embodiments of the present disclosure, and are not used for the purpose of specifically limiting the contents of the present disclosure, and it should be noted that the terms are defined by considering various possibilities of the present disclosure.

Further, in this specification, it should be understood that, unless the context clearly indicates otherwise, the expression in the singular may include a plurality of expressions, and similarly, even if it is expressed in plural, it should be understood that the meaning of the singular may be included.

In the case where it is stated throughout this specification that a component “includes” another component, it does not exclude any other component, but may further include any other component unless otherwise indicated.

Further, hereinafter, in describing the present disclosure, a detailed description of a configuration determined that may unnecessarily obscure the subject matter of the present disclosure, for example, a detailed description of a known technology including the prior art may be omitted.

Hereinafter, exemplary embodiments of the present disclosure will be described in detail with reference to related drawings.

The present disclosure relates to a method of separating an aluminum current collector from a cathode material of a lithium battery for recycling or reusing spent lithium batteries.

In one exemplary embodiment of the present disclosure, the method relates to separating a cathode plate and an anode plate from a lithium iron phosphate (LiFePO₄) battery, impregnating the cathode material and the current collector in an aqueous solvent, and stirring the mixture to activate a delamination reaction of the cathode material, thereby separating the aluminum current collector from the cathode material of the lithium battery.

Furthermore, the present disclosure relates to an environmentally friendly method of separating an aluminum current collector from a cathode material of a lithium battery, which reduces process steps and chemical consumption compared to the conventional technology.

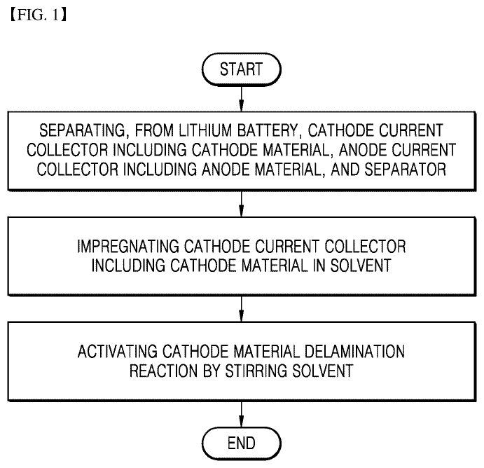

FIG. 1 is a process diagram illustrating a method of separating an aluminum current collector from a cathode material of a lithium battery according to an exemplary embodiment of the present disclosure.

As illustrated in FIG. 1, the method of separating an aluminum current collector from a cathode material of a lithium battery comprises:
(a) separating, from a lithium battery, a cathode current collector including a cathode material, an anode current collector including an anode material, and a separator;
(b) impregnating the cathode current collector including the cathode material in a solvent; and
(c) activating a cathode material delamination reaction by stirring the solvent.

Step (a) is a step of separating a cathode current collector including a cathode material, an anode current collector including an anode material, and a separator from a prepared lithium battery.

The prepared lithium battery may be a spent lithium battery after use or a scrap generated during the lithium battery manufacturing process, but is not limited thereto.

Here, the lithium battery is not particularly limited in type, as long as it is a lithium battery to which the method of separating an aluminum current collector from a cathode material of a lithium battery according to the present disclosure can be applied. Examples without limitation include ternary batteries (NiCoMn, NiCoAl, NiCoMnAl) and lithium iron phosphate (LiFePO₄) batteries, and preferably, a lithium iron phosphate battery may be used.

A lithium battery includes a cathode material, an anode material, an electrolyte, a separator, and a current collector. The cathode material includes a cathode active material, a conducting agent, and a binder.

The cathode active material plays a role in providing lithium ions to the anode during battery charging and may include, for example, lithium iron phosphate (LFP), lithium cobalt oxide (LCO), lithium manganese oxide (LMO), and nickel cobalt manganese (NCM).

The conducting agent facilitates the movement of electrons between cathode active material particles, and may include, for example, carbon nanotubes (CNT), carbon black, acetylene black, and Ketjen black.

The binder serves an important role in effectively connecting the cathode active material and the conducting agent, firmly attaching them to the current collector plate, and improving the durability of the electrode. Specifically, the cathode binder is required to have electrochemical stability in the presence of the electrolyte, flexibility and insolubility, and oxidation resistance. For examples, the cathode binder may include Poly VinyliDeneFluoride (PVDF) and PolyTetraFluoroEthylene (PTFE). The binder may be generally contained in an amount of about 3 to 5 wt %.

The cathode material may be manufactured using known methods and general knowledge of those skilled in the art, using the cathode active material, conducting agent, and binder. In general, the cathode active material, conducting agent, and binder are mixed in a stirrer, and the mixture is made into a slurry with a solvent. The resulting slurry is uniformly coated onto the upper surface of the cathode current collector using a coating reactor. The coated cathode material is then dried and compressed to increase its density, and the dried and compressed cathode material is cut to an appropriate size and assembled into a battery cell.

Therefore, in order to separate and recover the cathode material and the aluminum current collector from the cathode material of the lithium battery, a process of dissolving the binder from the compressed cathode material is required.

The cathode material may include a binder containing polyvinylidene fluoride (PVDF).

In the process of manufacturing a cathode material for a lithium battery, a mixture of a cathode active material, a conducting agent, and a polyvinylidene fluoride (PVDF) binder is mixed with N-methyl-2-pyrrolidone (NMP) solvent to form a slurry, which is then coated onto an aluminum substrate serving as the cathode current collector and dried. During the drying process, the NMP solvent is removed, and hydrogen bonding is formed between PVDF molecules. The formed hydrogen bonds can be broken using an appropriate solvent, thereby enabling separation of the cathode material and the aluminum current collector.

Step (b) is a step of impregnating a cathode current collector including a cathode material, which has been separated from the lithium battery, in a solvent.

In one exemplary embodiment of the present disclosure, the cathode current collector separated from a spent lithium battery contains a portion of the electrolyte, and it is therefore preferable to remove the residual electrolyte remaining on the electrode surface before impregnating the cathode current collector including the cathode material in a solvent. However, in another exemplary embodiment of the present disclosure, when impregnating the cathode current collector including the cathode material, which is obtained from scrap generated during the lithium battery manufacturing process, in a solvent, the electrolyte removal process is not required.

In step (b), the solvent may be an aqueous or non-aqueous solvent.

The cathode current collector including a cathode material, which is separated from a lithium battery, may be treated with a solvent capable of breaking hydrogen bonds formed between polyvinylidene fluoride (PVDF) molecules. A substance capable of hydrogen bonding is a polar molecule that generates an intramolecular dipole moment, and a polar aqueous or non-aqueous solvent may be used to break the hydrogen bonds formed between PVDF molecules. As a result, the cathode material and the aluminum current collector can be separated.

In addition, the aqueous solvent may be any one selected from the group consisting of water, distilled water, and deionized water.

Here, when the cathode current collector including the cathode material is impregnated with the aqueous solvent, the aqueous solvent, which is a polar solvent capable of breaking the hydrogen bonds formed between the polyvinylidene fluoride (PVDF) molecules, can break the hydrogen bonds between the PVDF molecules, thereby enabling the separation of the cathode material and the aluminum current collector.

In the conventional art, methods primarily used to separate the cathode material and the aluminum current collector from a lithium battery involve immersing them in acidic solutions, alkaline solutions, hydroxide solutions of alkali metals, alcohol solutions of alkali metals, or organic solvents. However, these conventional methods have the drawbacks of long electrode delamination and recovery times, difficulty in controlling an appropriate pH, the need to adjust the concentration of acids or bases depending on the pH, and process control issues such as metal leaching depending on the pH.

In contrast to the conventional art, the present disclosure provides a method that allows for the recovery of both the cathode material and the aluminum current collector from the cathode material of a lithium battery in an environmentally friendly manner, without the use of acids or alkalis.

In addition, compared to the conventional art, the present disclosure allows for the recovery of both the cathode material and the aluminum current collector without deteriorating the electrochemical performance of the cathode material.

In step (b), the cathode current collector including the cathode material may be impregnated in an amount of 1 to 3 wt % based on 100 wt % of the solvent.

When the cathode current collector including the cathode material is impregnated in an amount of less than 1 wt % based on 100 wt % of the solvent, the recovery amount of the cathode material and the aluminum current collector from the cathode current collector may be low, which may increase the time required for mass production. On the other hand, when the cathode current collector including the cathode material is impregnated in an amount exceeding 3 wt %, the entire cathode current collector may not be fully immersed in the solvent, the binder may not be sufficiently dissolved, the delamination reaction of the cathode material may not occur completely, and the recovery yield of the cathode material and the aluminum current collector may be reduced.

Step (c) is a step of impregnating the cathode current collector including the cathode material in a solvent and then stirring the solvent to delaminate the cathode material.

The step (c) may be performed at a temperature of 10 to 15° C.

Here, when the solvent containing the cathode current collector is agitated within the specified temperature range, hydrogen bonds formed between polyvinylidene fluoride (PVDF) molecules in the cathode material can be broken even at a lower temperature compared to conventional methods, thereby allowing the cathode material to be delaminated from the cathode current collector. As a result, both the cathode material and the aluminum current collector can be recovered without deterioration in electrochemical performance.

The step (c) may be performed at 300 to 400 rpm.

In the conventional art, to separate the cathode material and the aluminum current collector from a lithium battery, a method is used in which the electrode is immersed in an aqueous or non-aqueous solvent, followed by heating, agitation, and the application of ultrasonic waves. However, such conventional methods require an additional step of applying ultrasonic waves, resulting in a more complex process and increased process costs.

In contrast to the conventional art, the present disclosure enables the recovery of both the cathode material and the aluminum current collector from the cathode material of a lithium battery without applying ultrasonic waves.

Here, when the solvent containing the cathode current collector is agitated within the specified agitation speed range, the delamination reaction of the cathode material can occur completely even with lower fluid force compared to conventional methods. As a result, the hydrogen bonds formed between polyvinylidene fluoride (PVDF) molecules in the cathode material can be broken, allowing the cathode material to be delaminated from the cathode current collector, and both the cathode material and the aluminum current collector can be recovered without deterioration in electrochemical performance.

In step (c), the cathode material delamination reaction may be performed for 15 to 25 minutes.

In the conventional art, to separate the cathode material and the aluminum current collector from a lithium battery, a method is employed in which the electrode is immersed in an aqueous or non-aqueous solvent, followed by heating, agitation, and application of ultrasonic waves, in order to reduce the process time. However, such conventional methods require additional steps, resulting in a more complex process and increased process costs.

In contrast to the conventional art, the present disclosure enables the recovery of both the cathode material and the aluminum current collector from the cathode material of a lithium battery without requiring additional steps.

Here, when the delamination reaction of the cathode material is performed within the specified reaction time, the delamination reaction can be fully carried out in a shorter time compared to conventional methods. As a result, hydrogen bonds formed between polyvinylidene fluoride (PVDF) molecules in the cathode material can be broken, allowing the cathode material to be delaminated from the cathode current collector, and both the cathode material and the aluminum current collector can be recovered without deterioration in electrochemical performance.

When the delamination reaction time of the cathode material is less than 15 minutes, the time may be insufficient to break the hydrogen bonds between the PVDF molecules, and the delamination reaction may not occur completely. On the other hand, when the delamination reaction time exceeds 25 minutes, only the process time increases, and the delamination reaction may not be further promoted.

According to an exemplary embodiment of the present disclosure, the method may further comprise, after step (c), a step of recovering the aluminum current collector.

The recovered aluminum current collector in the step of recovering the aluminum current collector may be recycled or reused through a washing step and/or a cutting step to a predetermined size. In addition, since the recovered aluminum does not exhibit deterioration in electrochemical performance, the recovered aluminum can be reused in the manufacture of lithium batteries.

After step (c), the pH of the solvent may be in a range of 7 to 9.

In the conventional art, a method of immersing the electrode in an acidic or alkaline solution is primarily used to separate the cathode material and the aluminum current collector from a lithium battery. However, such a method causes environmental pollution and requires an additional wastewater treatment process for the waste liquid generated during the process.

In contrast to the conventional art, the present disclosure enables the environmentally friendly recovery of both the cathode material and the aluminum current collector from the cathode material of a lithium battery without using acidic or alkaline solutions.

In addition, according to the present disclosure, the pH of the solvent after the delamination reaction of the cathode material remains at a mildly alkaline level, so the solvent can be recovered without a special wastewater treatment process and reused for delaminating the cathode material and the aluminum current collector from a lithium battery.

After step (c), a lithium content of the solvent may be 20 ppm or less.

When the lithium content of the solvent exceeds 20 ppm after step (c), lithium metal may have been leached into the solvent, which may make it difficult to reuse the recovered solvent as it is. Furthermore, the electrochemical performance of the cathode material recovered from the cathode material of the lithium battery may deteriorate, making it difficult to reuse the material in the manufacture of lithium batteries.

As described above, the method of separating an aluminum current collector from a cathode material of a lithium battery according to an exemplary embodiment of the present disclosure has the effect of reducing process steps in technologies for recycling or reusing spent lithium batteries, and enabling the separation and reuse of the cathode material and the current collector without using chemical agents such as acids or alkalis, thereby providing an environmentally friendly process. In addition, since the method employs a simple and facile process, it allows for easy process control and is suitable for mass production, and enables the recovery of both the cathode material and the aluminum current collector without deterioration in electrochemical performance.

Hereinafter, the effect of recovering the cathode material and the aluminum current collector without deterioration in electrochemical performance through the simple and facile process according to an exemplary embodiment of the present disclosure will be described with reference to the following experimental examples.

### EXEMPLARY EMBODIMENTS

### <Exemplary Embodiment 1> Method of Separating an Aluminum Current Collector from a Cathode Material of a Lithium Battery

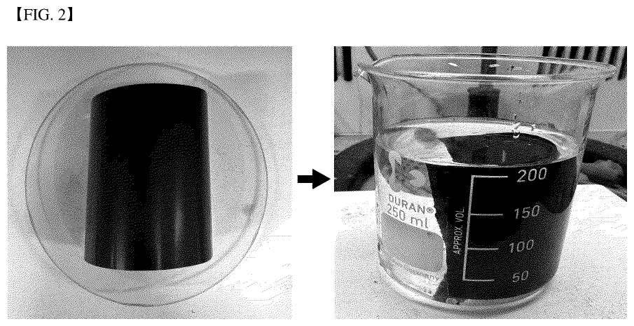

FIG. 2 is a photograph showing a cathode current collector of a lithium battery impregnated in a solvent according to an exemplary embodiment of the method of separating an aluminum current collector from a cathode material of a lithium battery of the present disclosure.

As shown in FIG. 2, a spent cylindrical lithium iron phosphate (LiFePO₄)-based lithium battery was disassembled to prepare a cathode current collector. The electrolyte remaining on the prepared cathode current collector was removed by washing with an organic solvent. The cathode current collector prepared in Exemplary Embodiment 1 includes a cathode material composed of lithium iron phosphate (LiFePO₄) as the cathode active material, carbon black, and a polyvinylidene fluoride (PVDF) binder, and an aluminum current collector. The weight was 2.024 g.

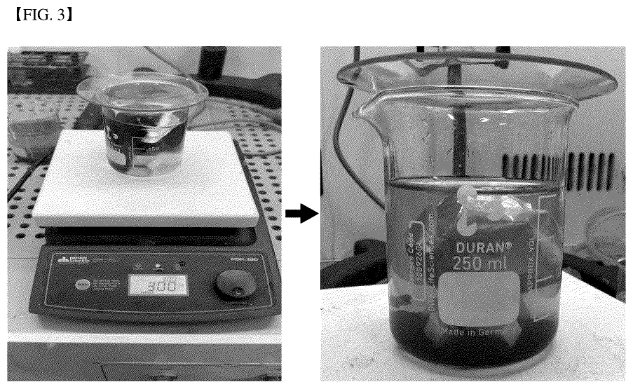

FIG. 3 is a photograph showing a delamination reaction of the cathode material performed according to an exemplary embodiment of the method of separating an aluminum current collector from a cathode material of a lithium battery of the present disclosure.

As shown in FIG. 3, the cathode current collector was impregnated in deionized (DI) water having the pH of 5.27, and then agitated to initiate the delamination reaction of the cathode material. The conditions for performing the cathode material delamination reaction are shown in Table 1 below.

TABLE 1

| | |
|---|---|
| Weight (g) | 2.024 |
| Solvent | Deionized Water |
| Temperature (° C.) | 15 |
| Stirrer | Magnetic Bar, 4 cm |
| Stirring Speed (rpm) | 300 |
| Time (min.) | 20 |
| Initial pH | 5.27 |
| Final pH | 8.92 |

Referring to Table 1, the aluminum current collector was recovered after stirring the deionized water, in which the cathode current collector was impregnated, for 20 minutes using a 4 cm magnetic bar at a temperature of 15° C. and a stirring speed of 300 rpm.

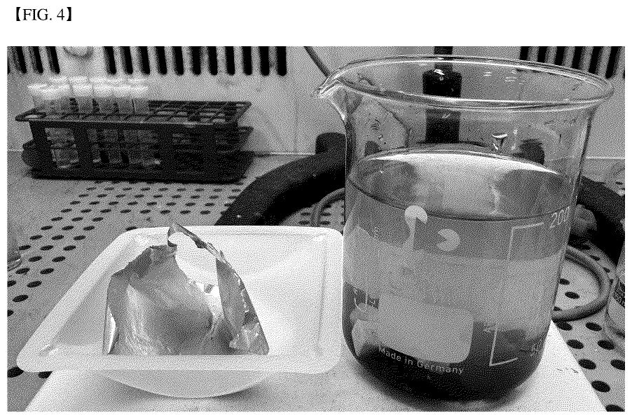

FIG. 4 is a photograph showing the recovered aluminum current collector after delamination, according to an exemplary embodiment of the method of separating an aluminum current collector from a cathode material of a lithium battery of the present disclosure.

As shown in FIG. 4, it was confirmed that, according to the method of separating an aluminum current collector from a cathode material of a lithium battery of the present disclosure, an aluminum current collector with no deterioration in electrochemical performance was successfully recovered in a short time at a low temperature through a simple, facile, and environmentally friendly process.

After recovering the aluminum current collector, the pH of the deionized water was measured to be 8.92, indicating a mildly alkaline state. Therefore, the deionized water after recovery of the aluminum current collector can be reused as it is for delaminating the cathode material and the aluminum current collector from a lithium battery, without requiring a separate wastewater treatment process.

### <Exemplary Embodiment 2> Method of Separating an Aluminum Current Collector from a Cathode Material of a Lithium Battery

A spent cylindrical lithium iron phosphate (LiFePO₄)-based lithium battery was disassembled to prepare a cathode current collector. The electrolyte remaining on the prepared cathode current collector was removed by washing with an organic solvent. The cathode current collector prepared in Exemplary Embodiment 2 was the same as that of Exemplary Embodiment 1, except that its weight was 2.125 g.

The cathode current collector was impregnated in deionized (DI) water having the pH of 6.22, and then agitated to initiate the delamination reaction of the cathode material. The conditions for performing the cathode material delamination reaction are shown in Table 2 below.

TABLE 2

| | |
|---|---|
| Weight (g) | 2.125 |
| Solvent | Deionized Water |
| Temperature (° C.) | 15 |
| Stirrer | Magnetic Bar, 3 cross-shaped |
| Stirring Speed (rpm) | 300 |
| Time (min.) | 20 |
| Initial pH | 6.22 |
| Final pH | 8.29 |

Referring to Table 2, the deionized water in which the cathode current collector was impregnated was agitated using a 3 cm cross-shaped magnetic bar at a temperature of 15° C. and a stirring speed of 300 rpm for 20 minutes, and the separated aluminum current collector was recovered.

As shown in FIG. 4, it was confirmed that, according to the method of separating an aluminum current collector from a cathode material of a lithium battery of the present disclosure, an aluminum current collector with no deterioration in electrochemical performance was successfully recovered in a short time at a low temperature through a simple, facile, and environmentally friendly process.

After recovering the aluminum current collector, the pH of the deionized water was measured to be 8.29, indicating a mildly alkaline state. Therefore, the deionized water after recovery of the aluminum current collector can be reused as is for delaminating the cathode material and the aluminum current collector from a lithium battery, without requiring a separate wastewater treatment process.

### <Exemplary Embodiment 3> Method of Separating an Aluminum Current Collector from a Cathode Material of a Lithium Battery

A spent cylindrical lithium iron phosphate (LiFePO₄)-based lithium battery was disassembled to prepare a cathode current collector. The electrolyte remaining on the prepared cathode current collector was removed by washing with an organic solvent. The cathode current collector prepared in Exemplary Embodiment 3 was the same as that of Exemplary Embodiment 1, except that its weight was 2.027 g.

The cathode current collector was impregnated in deionized (DI) water having the pH of 5.19, and then agitated to initiate the delamination reaction of the cathode material. The conditions for performing the cathode material delamination reaction are shown in Table 3 below.

TABLE 3

| | |
|---|---|
| Weight (g) | 2.027 |
| Solvent | Deionized Water |
| Temperature (° C.) | 15 |
| Stirrer | Magnetic Bar, 5 cm |
| Stirring Speed (rpm) | 300 |
| Time (min.) | 18 |
| Initial pH | 5.19 |
| Final pH | 7.12 |

Referring to Table 3, the deionized water in which the cathode current collector was impregnated was agitated using a 5 cm magnetic bar at a temperature of 15° C. and a stirring speed of 300 rpm for 18 minutes, and the separated aluminum current collector was recovered.

As shown in FIG. 4, it was confirmed that, according to the method of separating an aluminum current collector from a cathode material of a lithium battery of the present disclosure, an aluminum current collector with no deterioration in electrochemical performance was successfully recovered in a short time at a low temperature through a simple, facile, and environmentally friendly process.

After recovering the aluminum current collector, the pH of the deionized water was measured to be 7.12, indicating a mildly alkaline state. Therefore, the deionized water after recovery of the aluminum current collector can be reused as it is for delaminating the cathode material and the aluminum current collector from a lithium battery, without requiring a separate wastewater treatment process.

### EXPERIMENTAL EXAMPLE

### <Experimental Example 1> ICP Analysis of Solution After Recovery of Aluminum Current Collector

In Exemplary Embodiment 3 described above, after recovering the aluminum current collector using the method of separating an aluminum current collector from a cathode material of a lithium battery, the solution was analyzed using an inductively coupled plasma optical emission spectrometer (ICP-OES). The analysis results are shown in Table 4 below.

TABLE 4

| Element | Li | Fe | Al | P |
|---|---|---|---|---|
| Concentration (ppm) | 15.031 | 2.538 | 2.415 | 0 |

Referring to Table 4, it was confirmed that trace amounts of lithium (Li), iron (Fe), and aluminum (Al) were leached into the solution after recovery of the aluminum current collector. In particular, the concentration of lithium (Li) leached into the deionized water was approximately 15 ppm.

FIG. 4 is a photograph showing the recovered aluminum current collector after delamination, according to an exemplary embodiment of the method of separating an aluminum current collector from a cathode material of a lithium battery of the present disclosure.

As shown in FIG. 4, it was confirmed that the cathode material was precipitated at the bottom of the solution. Therefore, it was confirmed that both the cathode material and the aluminum current collector, without deterioration in electrochemical performance, could be recovered by the method of the present disclosure.

In the above, although several preferred embodiments of the present disclosure have been described with some examples, the descriptions of various exemplary embodiments described in the “Detailed Description of the Disclosure” item are merely exemplary, and it will be appreciated by those skilled in the art that the present disclosure can be variously modified and carried out or equivalent executions to the present disclosure can be performed from the above description.

In addition, since the present disclosure can be implemented in various other forms, the present disclosure is not limited by the above description, and the above description is for the purpose of completing the disclosure of the present disclosure, and the above description is just provided to completely inform those skilled in the art of the scope of the present disclosure, and it should be known that the present disclosure is only defined by each of the claims.

According to an exemplary embodiment of the present disclosure, there is provided a method of separating an aluminum current collector from a cathode material of a lithium battery, which reduces process steps and chemical consumption in technologies for recycling or reusing spent lithium batteries.

In addition, according to an exemplary embodiment of the present disclosure, there is provided an environmentally friendly method of separating an aluminum current collector from a cathode material of a lithium battery, which enables the cathode material and the current collector to be separated and reused without the use of an acid or an alkali.

In addition, according to an exemplary embodiment of the present disclosure, there is provided a method of separating an aluminum current collector from a cathode material of a lithium battery, which mitigates environmental pollution and reduces process costs by eliminating the need for a neutralization process or wastewater treatment.

In addition, according to an exemplary embodiment of the present disclosure, there is provided a method of separating an aluminum current collector from a cathode material of a lithium battery, which allows for easy process control and is suitable for mass production by employing a simple and facile process.

In addition, according to an exemplary embodiment of the present disclosure, there is provided a method of separating an aluminum current collector, which enables the recovery of both a cathode material and an aluminum current collector without deterioration in electrochemical performance.

What is claimed is:

1. A method of separating an aluminum current collector from a cathode material of a lithium battery, the method comprising:
(a) separating, from a lithium battery, a cathode current collector including a cathode material, an anode current collector including an anode material, and a separator;
(b) impregnating the cathode current collector including the cathode material in a solvent; and
(c) activating a cathode material delamination reaction by stirring the solvent.

2. The method of claim 1,
wherein the cathode material includes a binder containing polyvinylidene fluoride (PVDF).

3. The method of claim 1,
wherein, in step (b), the solvent is an aqueous or non-aqueous solvent.

4. The method of claim 3,
wherein the aqueous solvent is any one selected from the group consisting of water, distilled water, and deionized water.

5. The method of claim 1,
wherein, in step (b), the cathode current collector including the cathode material is impregnated in an amount of 1 to 3 wt % based on 100 wt % of the solvent.

6. The method of claim 1,
wherein step (c) is performed at a temperature of 10 to 15° C.

7. The method of claim 1,
wherein step (c) is performed at 300 to 400 rpm.

8. The method of claim 1,
wherein, in step (c), the cathode material delamination reaction is performed for 15 to 25 minutes.

9. The method of claim 1,
further comprising, after step (c), a step of recovering the aluminum current collector.

10. The method of claim 1,
wherein, after step (c), the pH of the solvent is in a range of 7 to 9.

11. The method of claim 1,
wherein, after step (c), a lithium content of the solvent is 20 ppm or less.
